(19) United States
(12) Patent Application Publication
(10) Pub. No.: US 2025/0243939 A1
(43) Pub. Date: Jul. 31, 2025

(54) BOWED ECCENTRIC PLUG VALVE SEAT AND PLUG

(71) Applicant: MCWANE, INC.

(72) Inventor: Paul Kennedy, Horseheads, NY (US)

(21) Appl. No.: 19/040,833

(22) Filed: Jan. 29, 2025

Related U.S. Application Data
(60) Provisional application No. 63/626,274, filed on Jan. 29, 2024.

(51) Int. Cl. F16K 5/04

(52) U.S. Cl. CPC F16K 5/0407; F16K 5/0464

(57) ABSTRACT

An eccentric plug valve has a valve body having a cavity between a first fluid passage port and a plug engaging fluid passage port positioned within the valve body to define a fluid flow path with a central axis through the cavity. The valve includes a plug located within the cavity configured to rotate between a fully open position and a fully closed position about an axis that is eccentric relative to the fluid flow path. The valve includes a plug seat on the plug engaging fluid passage port that is configured to engage the plug when it is in the fully closed position preventing fluid flow though the eccentric plug valve by being shaped to compensate for deflection of the plug while the valve is closed to facilitate more uniform friction along the surfaces of the plug and plug seat.

### BACKGROUND

The present invention relates to valves, and more specifically to eccentric plug valves.

FIG. 1 illustrates a conventional eccentric plug valve 1. An eccentric plug valve is a style of rotary control valve with a plug shaped, flow restricting member 10 that follows an eccentric path off center from the flow path and center of the valve 1 as it rotates. In other words, the plug 10 rotates around an axis that is offset relative to the center of the valve 1. The purpose of the eccentric path is to allow the plug 10 to rotate with no contact with the valve seat 11 until it turns within a few degrees of the shut off position. This reduces friction while the plug is rotating.

The port 12 in the valve 1 is typically rectangular in cross section while the plug 10 is cylindrical on its face that engages the seat 11 and can be flat on its face away from the seat 11. The cylindrical plug 10 and rectangular port 12 provide a rotational alignment by the eccentric motion making a uniform and full contact with the valve seat 11. Unlike circular port designs (e.g., ball valves) that have point-to-point seating where engagement and wear can be an issue, the rectangular port makes a uniform and full contact without the need for exact alignment of the plug in the body.

The plug 10 is connected to a shaft 14 exiting the body 13 through a body cover plate 15 that is attached to the body 13 with bolts 16. The shaft is typically sealed with PTFE thrust bearings 17 on plug journals 18 to reduce operating force and wear to the plug 10 and body cover 15. The shaft 14 can be attached to many assorted types of actuators can be used to operate an eccentric plug valve, e.g., electric, pneumatic, and hydraulic actuators, and will depend on application. In general, the actuator is a very expensive component relative to the other parts of the assembly, and the cost associated with the actuator is directly proportional to the maximum amount of torque that the actuator must be able to exert in order to overcome friction when actuating the valve 1. As such, it is desirable to reduce the amount of friction that is generated between the plug 10 and the seat 11 when the plug 10 is in full contact with the seat 11, while still maintaining a fluid-tight seal, allowing a more cost effective and smaller actuator.

When the plug 10 is rotated to a fully open position, the plug 10 does not impede flow through the valve 1 which allows laminar flow in the body 13 through the port 12, resulting in low lead loss. This allows for passage of larger solids preventing clogging or build up. When the plug 10 is rotated to a fully closed position, the plug 10 engages the seat 11 along the edges of its face to form a fluid-tight seal and block flow through the valve 1. The actuator must overcome the friction between the plug 10 and the seat 11 to properly rotate the plug 10 into and out of the fully closed position. When an eccentric plug valve 1 is installed in a horizontal line, the preferred installation is with the plug 10 rotating 90° upward to open. Utilizing this orientation can lessen the effect of solids preventing plug 10 operation. In low pressure/low flow systems with solids present, it is preferred to install the valve with flow against the plug 10 face, such that a build-up of solids within the body 13 is prevented. Eccentric plug valves may be installed vertically; however, whenever possible, horizontal orientation is preferred. When installed in a vertical line where solids exist, the seat 11 is ideally positioned up, preventing solid build-up in the valve body 13.

When installed in high pressure systems, conventionally, it is recommended to have the seat 11 on the outlet side of the valve 1, which may detrimentally cause solid build-up in the body 13. Installing the valve 1 in this manner is necessary for conventional designs because when the seat 11 is on the inlet side of the valve 1, the plug 10 suffers deflection (i.e., an elastic deformation of the material of the plug 10) at its center due to the high pressure exerted on its face and the curved shape of the plug 10, thereby causing leakage along the sides of the plug 10. On the other hand, when the seat 11 is on the outlet side of the valve 1, the high pressure exerted on the back side of the plug 10 presses the face of the plug 10 harder against the seat 11, thus ensuring a fluid-tight seal but also greatly increasing the amount of static friction that the actuator needs to overcome in order to rotate the plug 10 away from the fully closed position.

For these reasons, it is desirable to design a valve that can be installed in high pressure systems with its seat 11 on the inlet side of the valve 1, while maintaining a fluid-tight seal in the fully closed position and reducing friction between the plug 10 and the seat 11. Previous attempts at resolving this issue have included increasing the overall thickness of the plug 10 by progressively adding additional layers of rubber on its face until deflection of the plug 10 no longer causes leakage along the sides when the plug 10 is subjected to the desired maximum pressure rating of the valve 1 with the seat 11 on the inlet side. However, this approach unduly increases the friction between the plug 10 and the seat 11, such that a more expensive actuator capable of exerting a greater maximum torque is necessitated. Accordingly, current conventional eccentric plug valve designs that can be installed in a way that prevents solid build up in the body 13 in high pressure applications are much more expensive than other designs considering that a large portion of the total cost of the valve 1 consists of the cost of the actuator.

### SUMMARY

The present invention relates to further lowering the friction as the valve seals closed and is opened.

The present invention includes an eccentric plug valve that has a valve body having a cavity between a first fluid passage port and a plug engaging fluid passage port positioned within the valve body to define a fluid flow path with a central axis through the cavity. The valve includes a plug located within the cavity configured to rotate between a fully open position and a fully closed position about an axis that is eccentric relative to the fluid flow path. The valve includes a plug seat on the plug engaging fluid passage port that is configured to engage the plug when it is in the fully closed position preventing fluid flow though the eccentric plug valve by being shaped to compensate for deflection of the plug while the valve is closed to facilitate more uniform friction along the surfaces of the plug and plug seat.

In one embodiment, the valve can have a surface of the plug seat that is formed to be bowed outwards in the middle of the plug seat in the direction of fluid flow to compensate for fluid deflecting the middle of the plug in the direction of fluid flow.

In another embodiment, the valve can have a surface of the plug seat that is formed to be bowed inwards in the middle of the plug seat in the direction of fluid flow to compensate for fluid deflecting the middle of the plug in the direction of fluid flow.

In another embodiment, the valve can have a plug that is formed to be bowed in the direction of fluid flow to compensate for fluid deflecting the middle of the plug in the direction of fluid flow.

### BRIEF DESCRIPTION OF THE DRAWINGS

FIG. 1 shows a cut away view of a conventional eccentric plug valve.

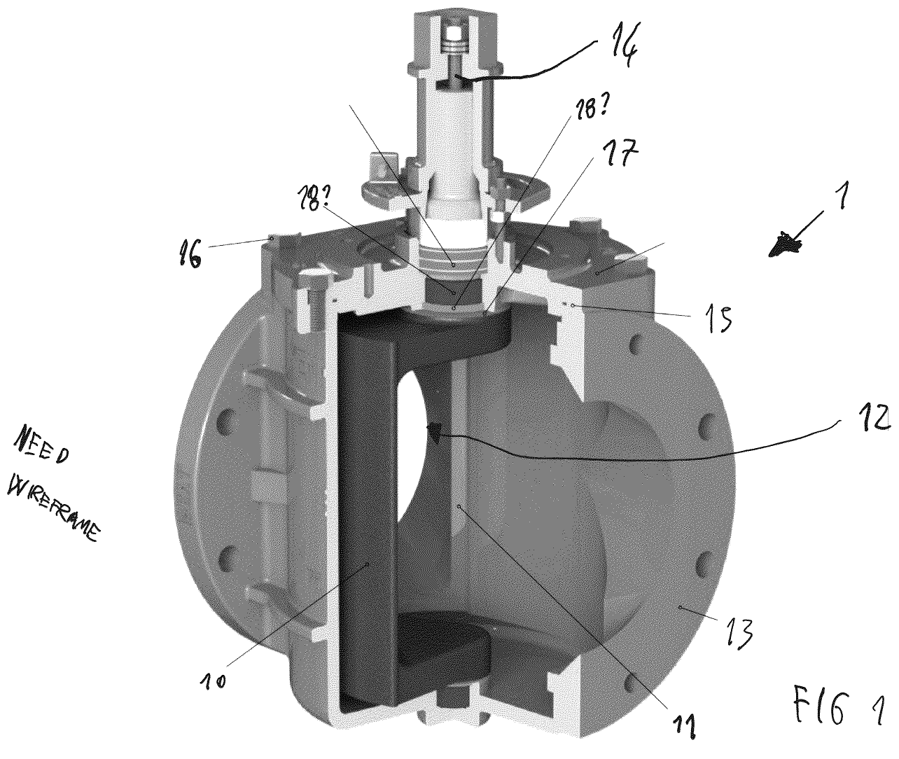

FIG. 2 shows a perspective cross-sectional view of an eccentric plug valve according to an embodiment.

FIG. 3 shows a cross-sectional view of an eccentric plug valve according to the embodiment of FIG. 2.

FIG. 4 shows a top view of an eccentric plug valve according to the embodiment of FIG. 2.

FIG. 5 shows a cross-sectional view of a valve seat according to the embodiment of FIG. 2.

FIG. 6 shows a cross-sectional view of a valve plug according to another embodiment.

### DETAILED DESCRIPTION

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings.

The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for case of description to describe one element or feature's relationship to another element(s) or feature(s) as illustrated in the Figures. Spatially relative terms may be intended to encompass different orientations of the device in use or operation in addition to the orientation depicted in the Figures. For example, if the device in the Figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

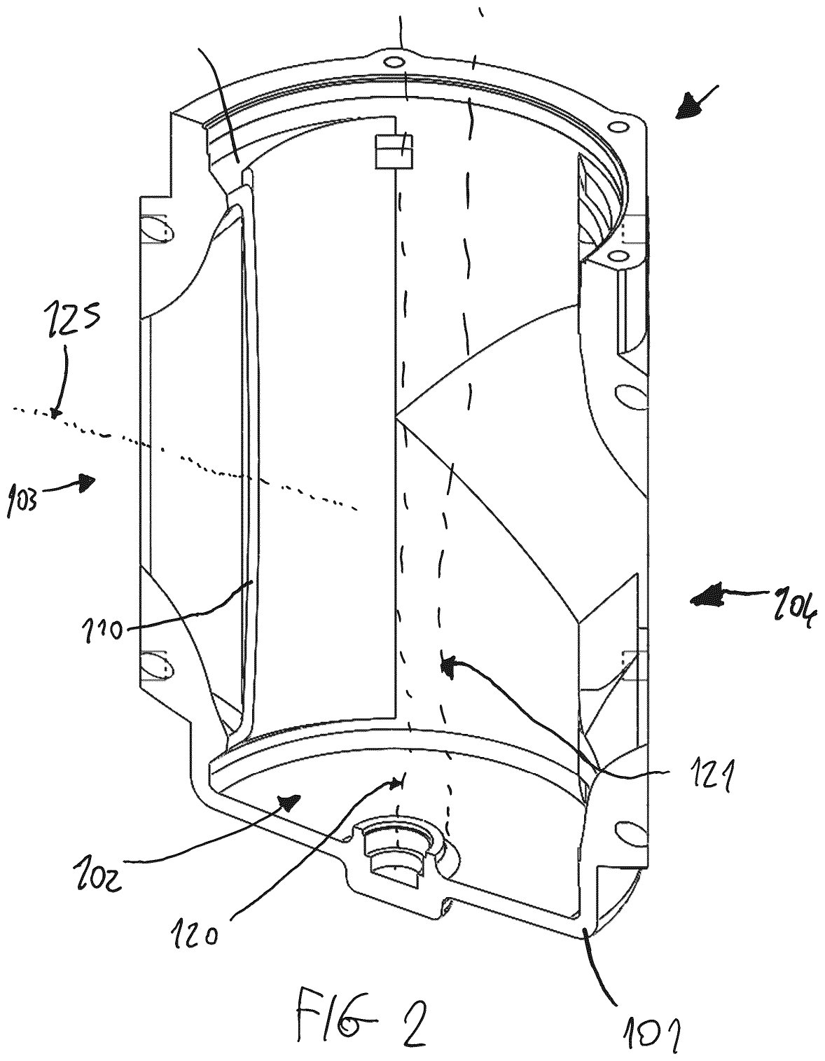

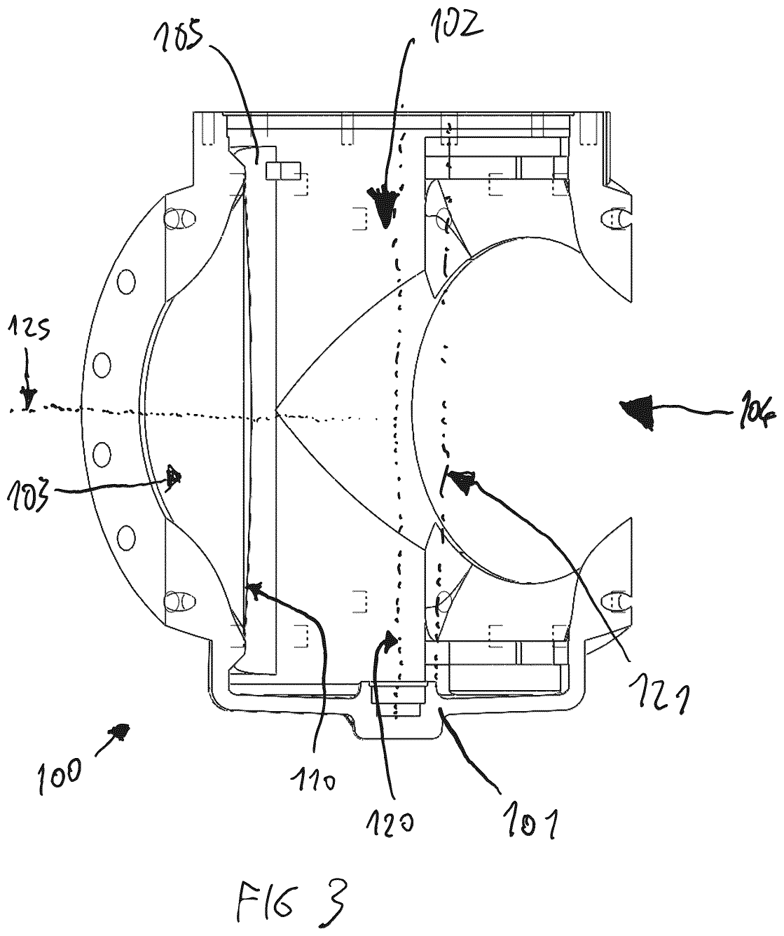

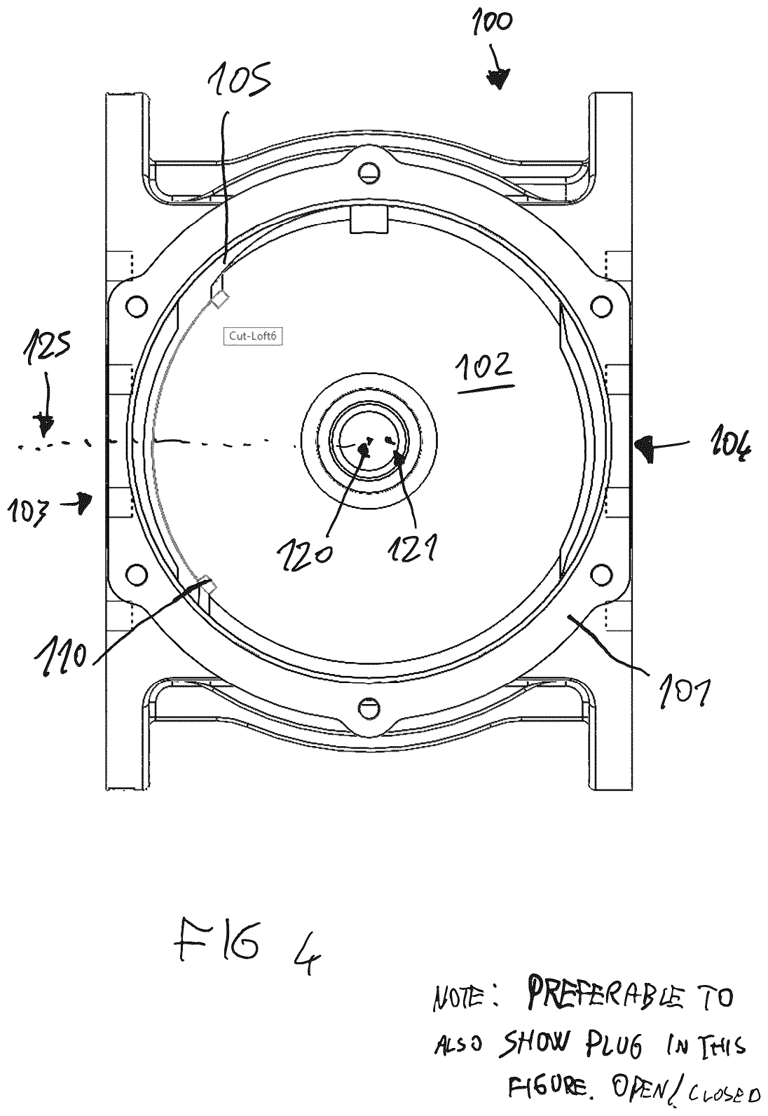

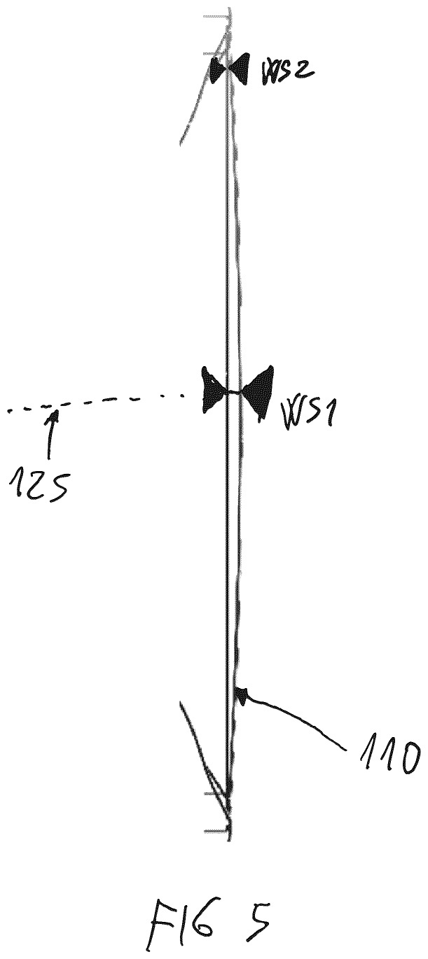

Referring to FIGS. 2-5 an embodiment of an eccentric plug valve 100 has a body 101 at least partially defining a cavity 102, an inlet 103 and an outlet 104 in fluid communication with the cavity 102. The body 101 can be made of stainless steel or similar material. The cavity 102 is essentially in the shape of a cylinder having a central axis 120, although deviation from a strictly cylindrical shape may be desired to optimize properties of the flow of fluids through the cavity 102. The inlet 103 is a flow channel centered around a channel axis 125 leading to a rectangular opening through an inner protrusion 105 of the curved side of the cylindrical cavity 102, such that the curvature of the rectangular opening is not centered at the central axis 120 but rather centered at an offset axis 121, with the central axis 120 being closer to the opening than the offset axis 121. At the intersection between the inlet 103 and the cavity 102, a plug seat 110 lines the inner wall of the protrusion 105 such that the seat 110 surrounds the rectangular opening along its edges. The plug seat 110 can be made of nickel or other material with similar properties. A plug 115 having a plug face essentially shaped as the side of a cylinder corresponding to the rectangular opening is located within the cavity 102 and configured to rotate about the central axis 120 when actuated by an actuator. The plug 115 can be made of rubber or other material with similar properties. Because the seat 110 is centered at the offset axis 121 instead of the central axis 120 while the plug 115 rotates around the central axis 120, the plug 115 makes contact along its edges with the seat 110 only when rotated to a fully closed position with the plug 115 facing the seat 110. When rotated away from the fully closed position, the plug 115 does not make contact with the seat 110. The plug 115 can be rotated approximately 90 degrees to a fully open position such that the plug 115 does not impede flow within the cavity 102 between the inlet 103 and the outlet 104.

As previously discussed, when the plug 115 is subjected to high pressure coming from the inlet side of the valve 100, the plug 115 suffers from deflection as the sides of the plug 115 are pushed inward towards the central axis 120. The plug 115 has a first end and a second end along the direction of the central axis 120, and a center equidistant to the first end and the second end. The deflection of the plug 115 causes maximum deformation towards the central axis 120 along the sides of the plug 115 at its center, and gradually less deformation from the center to each of the first end and the second end. In other words, maximum deformation of the plug 115 towards the central axis 120 is located at the intersection between the face of the plug 115 and a plane perpendicular to the central axis 120 and coplanar with the channel axis 125. The shape of this deformation is also known as an inwardly bowed shape, and the plug 115 is bowed inwards by the pressure exerted on the face of the plug.

According to the embodiment shown in FIGS. 2-5, to compensate for a maximum deformation length WD of the plug 115 (also called plug bowing depth), the seat 110 has a first end and a second end along the direction of the offset axis 121, and a center equidistant to the first end and the second end, with the width WS1 of the seat 110 at its center being approximately equal to or greater (by not more than 10%) than the maximum deformation length WD of the plug 115. The width of the seat 110 tapers to a thinner width towards each of the first end and the second end to account for lesser amounts of deformation of the plug 115 as distance from the center increases. In other words, the seat 110 has a first width WS1 at its center (also called seat bowing width) and a second width WS2 at its first end and second end, the first width being greater than the second width. Accordingly, the seat 110 is said to be bowed inwards to mimic the inwardly bowed shape of the deformation of the plug 115.

The plug bowing depth can be determined in advance through testing and/or calculation based on the expected pressure range that will be exerted on the plug 115 during normal operation of the valve 100 and the known material properties of the plug 115, allowing for manufacture of a seat 110 with a correspondingly sized seat bowing width, optimal for use at the specified pressure range.

An inwardly bowed seat 110 as described above is able to make full contact with the plug 115 when in the fully closed position even though deflection is present, thus forming a fluid-tight seal between the seat 110 and the plug 115. Accordingly, the valve 100 can be installed in a high pressure system with the inlet 103 and the face of the plug 115 facing against the flow without risking leakage, thus preventing build-up of solids within the cavity 102.

Further, experimentation has shown that inclusion of an inwardly bowed seat 110 does not materially increase static and dynamic friction between the seat 110 and the plug 115, and thus obviates the need for the stronger, larger, and much more expensive actuators that are required in order to properly to actuate conventionally designed eccentric plug valves that can be installed in a way that prevents solid build up in high pressure applications. As a result, valves 100 including an inwardly bowed seat 110 are considerably less expensive to manufacture when compared to other conventional designs.

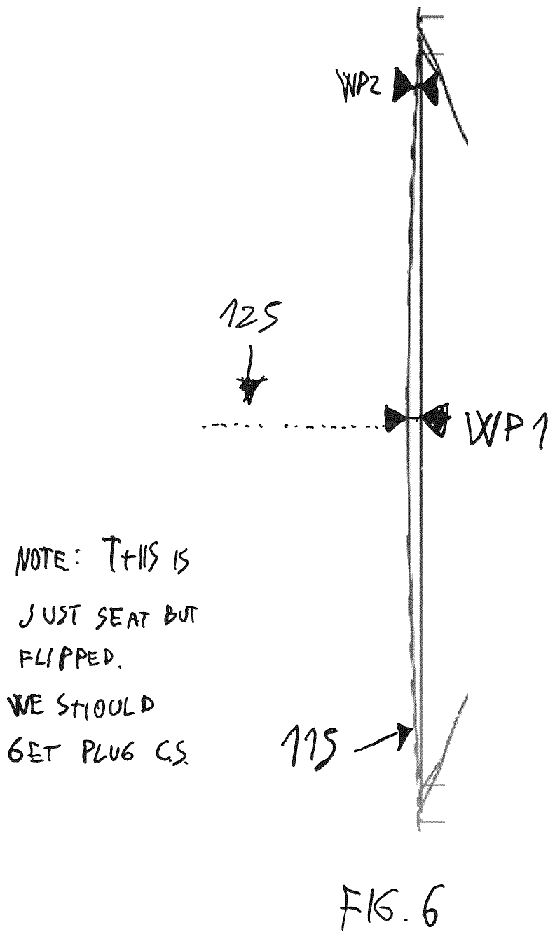

In another embodiment as shown in FIG. 6, to compensate for a maximum deformation length WD (also called plug bowing depth) of the plug 115, instead of the seat 110 being inwardly bowed, the plug 115 itself is outwardly bowed. On the face of the plug 115, more material is added in a bowed shape such that the width of the plug 115 along its center is increased, compared to an unmodified plug 115, by an outward bowing width WB that is approximately equal to or greater (by not more than 10%) than the maximum deformation length WD. The width of the plug 115 tapers to a thinner width towards each of the first end and the second end to account for lesser amounts of deformation of the plug 115 as distance from the center increases. In other words, the plug 115 has a first width WP1 at its center and a second width WP2 at its first end and second end, the first width being greater than the second width. Accordingly, the plug 115 is said to be bowed outwards to counter the inwardly bowed shape of the deformation of the plug 115. When the plug 115 is in the fully closed position.

The plug bowing depth can be determined in advance through testing and/or calculation based on the expected pressure range that will be exerted on the plug 115 during normal operation of the valve 100 and the known material properties of the plug 115, allowing for manufacture of a plug 115 with a correspondingly sized bowing width, optimal for use at the specified pressure range. When the expected pressure range is exerted on an outwardly bowed plug 115 with an appropriate outward bowing width WB, the plug 115 deforms to become essentially flat, akin to an unmodified plug 115 that is not experiencing deflection.

An outwardly bowed plug 115 as described above is able to make full contact with the seat 110 when in the fully closed position even though deflection is present, thus forming a fluid-tight seal between the seat 110 and the plug 115. Accordingly, the valve 100 can be installed in a high pressure system with the inlet 103 and the face of the plug 115 facing against the flow without risking leakage, thus preventing build-up of solids within the cavity 102.

Further, experimentation has shown that inclusion of an outwardly bowed plug 115 does not materially increase static and dynamic friction between the seat 110 and the plug 115, and thus obviates the need for the stronger, larger, and much more expensive actuators that are required in order to properly to actuate conventionally designed eccentric plug valves that can be installed in a way that prevents solid build up in high pressure applications. As a result, valves 100 including an outwardly bowed plug 115 are considerably less expensive to manufacture when compared to other conventional designs.

Other possible embodiments may include both an outwardly bowed plug 115 having a seat bowing width and an inwardly bowed seat 110 having a plug bowing width, with the total sum of the seat bowing width and the plug bowing width being approximately equal to or greater (by not more than 10%) than the plug bowing depth such that deflection of the plug 115 is appropriately compensated. However, it would be preferable to modify only one of the seat 110 and plug 115 according to either of the previously discussed embodiments in order to streamline the manufacturing process of the valve 100 and reduce costs.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An eccentric plug valve, comprising:
a valve body at least partially defining a cavity having a first central axis, the valve body having a fluid passage defining an opening to the cavity and having a second central axis, the second central axis perpendicular to the first central axis;
a plug configured to rotate between a first closed position and a second open position about a third central axis parallel to the first central axis; and
a plug seat around the opening to the cavity, the plug seat having a curved side centered about a fourth central axis;
wherein the curved side has a first end distal to the second central axis, a second end opposite the first end and distal to the second central axis, a center approximately equidistant between the first end and the second end and proximal to the second central axis, a first width at the first end and the second end, and a second width at the center, the second width greater than the first width.

2. The eccentric plug valve of claim 1, wherein the width of the curved side tapers between the center and each of the first end and the second end.

3. The eccentric plug valve of claim 1, wherein the third central axis is collinear with the first central axis and the fourth central axis is eccentric to the first central axis.

4. The eccentric plug valve of claim 1, wherein the plug abuts the curved side of the plug seat when the plug is rotated to the first closed position.

5. The eccentric plug valve of claim 1, wherein the cavity is at least partially in the shape of a cylinder.

6. The eccentric plug valve of claim 1, wherein the plug deforms by a maximum deformation length when in the first closed position and subjected to pressure, the second width of the curved side being approximately equal to the maximum deformation length.

7. An eccentric plug valve, comprising:
a valve body at least partially defining a cavity having a first central axis, the valve body having a fluid passage defining an opening to the cavity and having a second central axis, the second central axis perpendicular to the first central axis;
a plug configured to rotate between a first closed position and a second open position about a third central axis parallel to the first central axis, the plug having a first curved side; and
a plug seat around the opening to the cavity, the plug seat having a second curved side centered about a fourth central axis;
wherein the first curved side has a first end distal to the second central axis, a second end opposite the first end and distal to the second central axis, a center approximately equidistant between the first end and the second end and proximal to the second central axis, a first width at the first end and the second end, and a second width at the center, the second width greater than the first width.

8. The eccentric plug valve of claim 7, wherein the width of the first curved side tapers between the center and each of the first end and the second end.

9. The eccentric plug valve of claim 7, wherein the third central axis is collinear with the first central axis and the fourth central axis is eccentric to the first central axis.

10. The eccentric plug valve of claim 7, wherein the first curved side abuts the second curved side when the plug is rotated to the first closed position.

11. The eccentric plug valve of claim 7, wherein the plug deforms by a maximum deformation length when in the first closed position and subjected to pressure, the second width of the first curved side being approximately equal to the maximum deformation length.

12. An eccentric plug valve, comprising:
a valve body at least partially defining a cavity having a first central axis, the valve body having a fluid passage defining an opening to the cavity and having a second central axis, the second central axis perpendicular to the first central axis;
a plug configured to rotate between a first closed position and a second open position about a third central axis parallel to the first central axis, the plug having a first curved side; and
a plug seat around the opening to the cavity, the plug seat having a second curved side centered about a fourth central axis;
wherein the first curved side has a first end distal to the second central axis, a second end opposite the first end and distal to the second central axis, a first center approximately equidistant between the first end and the second end and proximal to the second central axis, a first width at the first end and the second end, and a second width at the first center, the second width greater than the first width; and
wherein the second curved side has a third end distal to the second central axis, a fourth end opposite the third end and distal to the second central axis, a second center approximately equidistant between the third end and the fourth end and proximal to the second central axis, a third width at the first end and the second end, and a fourth width at the center, the fourth width greater than the third width.

13. The eccentric plug valve of claim 12, wherein the width of the first curved side tapers between the first center and each of the first end and the second end.

14. The eccentric plug valve of claim 12, wherein the width of the second curved side tapers between the second center and each of the third end and the fourth end.

15. The eccentric plug valve of claim 12, wherein the plug deforms by a maximum deformation length when in the first closed position and subjected to pressure, the maximum deformation length being approximately equal to the sum of the second width of the first curved side and the fourth width of the second curved side.

16. The eccentric plug valve of claim 12, wherein the first curved side abuts the second curved side when the plug is rotated to the first closed position.

17. The eccentric plug valve of claim 12, wherein the third central axis is collinear with the first central axis and the fourth central axis is eccentric to the first central axis.
